(19) United States
(12) Patent Application Publication
(10) Pub. No.: US 2017/0124155 A1
(43) Pub. Date: May 4, 2017

(54) SPORTS DATA MATCHING SYSTEM AND METHOD

(71) Applicant: Zan Quan Technology Co., Ltd, Taipei City (TW)

(72) Inventors: Kai-Li Wang, Taipei City (TW); Hsia-Hung Ou, Taipei City (TW)

(21) Appl. No.: 14/925,487

(22) Filed: Oct. 28, 2015

(51) Int. Cl. G06F 17/30

(52) U.S. Cl. CPC G06F 17/30522

(57) ABSTRACT

A system for sports data matching is provided, which includes: a database for storing objective data; a portable electronic device for generating memory data and transmitting the memory data to the database; and a processing device electrically connected to the database and the portable electronic device for capturing the memory data generated by the portable electronic device and the objective data stored in the database and comparing the memory data with the objective data to generate comparison data, thereby facilitating a user to acquire information about the sports state and find virtual sports partners. A sports data matching method is also provided.

### BACKGROUND OF THE INVENTION

1. Field of the Invention

The present disclosure relates to sports data matching, and, more particularly, to a system and method for sports data matching to improve sports training and competition interactivity.

2. Description of Related Art

In recent years, people have become health conscious and spent more time in leisure activities. Further, portable consumer electronic products such as sports measurement devices have been developed, which are easily carried by people during a sports activity.

Generally, such a portable sports measurement device records only a part of environmental factors such as height, temperature and humidity of the sports place where the user is located. Since data on sports environment is not sufficient, it is difficult to compare and match sports data of the user with sports data of other users, which adversely affects the sports training and competition effect.

Therefore, how to overcome the above-described drawbacks has become critical.

### SUMMARY OF THE INVENTION

In view of the above-described drawbacks, the present disclosure provides a system for sports data matching, which comprises: a database configured to store objective data; a portable electronic device configured to generate memory data and transmit the memory data to the database; and a processing device electrically connected to the database and the portable electronic device, and configured to capture the memory data generated by the portable electronic device and the objective data stored in the database and compare the memory data with the objective data to generate comparison data.

The present disclosure further provides a method for sports data matching, which comprises: generating memory data and transmitting the memory data to a database stored with objective data by a portable electronic device; receiving the objective data stored in the database and the memory data generated by the portable electronic device and comparing the memory data with the objective data to generate comparison data by a processing device; and integrating the comparison data and the memory data to generate result data and transmitting the result data to the database for storage by the processing device.

According to the present disclosure, the portable electronic device provides data on current sports environment for comparison and analysis so as to facilitate finding appropriate virtual sports partners.

Further, users can capture results of different types of sports from the database and share them in a community website, thereby increasing the interactivity between the users. Furthermore, by querying the objective data of the database, history sports records can be acquired so as to facilitate to adjust the sports state and find appropriate virtual sports partners, thereby improving the sports training effect, facilitating rapid formation of a team for competition, and increasing the interactivity between the users.

### BRIEF DESCRIPTION OF DRAWINGS

FIGS. 1A to 1C are schematic block diagrams showing a system for sports data matching according to the present disclosure;

FIG. 2 is a schematic block diagram showing an example of the system for sports data matching according to the present disclosure;

FIG. 3 is a schematic block diagram showing a processing device of the system for sports data matching according to the present disclosure;

FIG. 4 is a schematic block diagram showing another example of the system for sports data matching according to the present disclosure; and

FIG. 5 is a schematic flow diagram showing a method for sports data matching according to the present disclosure.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

It should be noted that all the drawings are not intended to limit the present disclosure. Various modifications and variations can be made without departing from the spirit of the present disclosure.

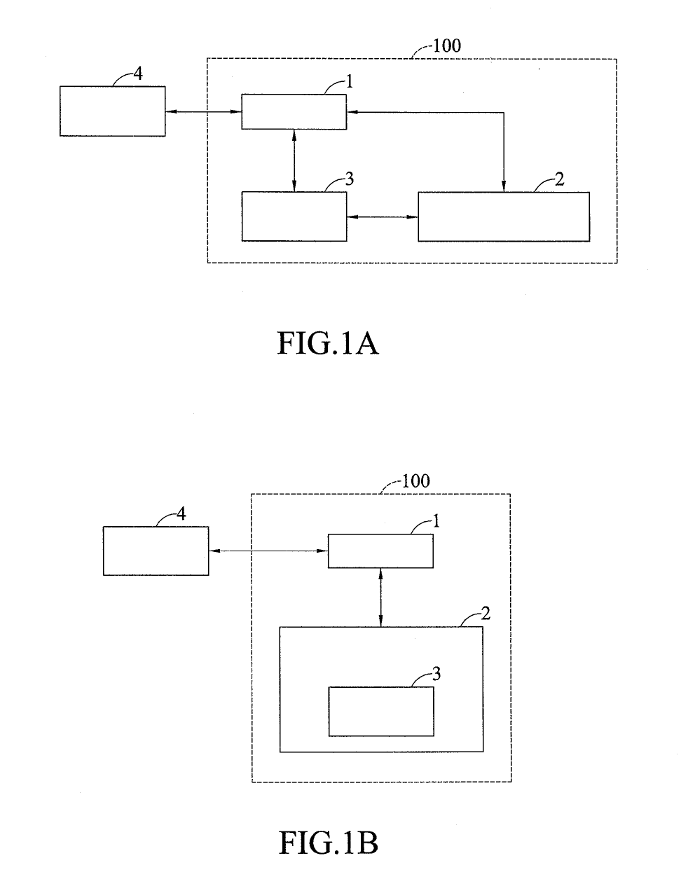

FIGS. 1A to 1C are schematic block diagrams showing a system 100 for sports data matching according to the present disclosure. The system 100 has a database 1 for storing data, a portable electronic device 2 electrically connected to the database 1, and a processing device 3 electrically connected to the database 1 and the portable electronic device 2. As shown in FIG. 1A, the processing device 3 can be positioned out of the database 1 and the portable electronic device 2. Alternatively, as shown in FIGS. 1B and 1C, the processing device 3 can be positioned in either one or both of the database 1 and the portable electronic device 2. The database 1 of the system 100 can be accessed by a community website 4. As such, sports data can be shared to increase the interactivity between users. For example, a friend in the community website 4 can access sports data of a user, and sports data of the friend can also be accessed by the user, thereby increasing the interactivity between the user and the friend.

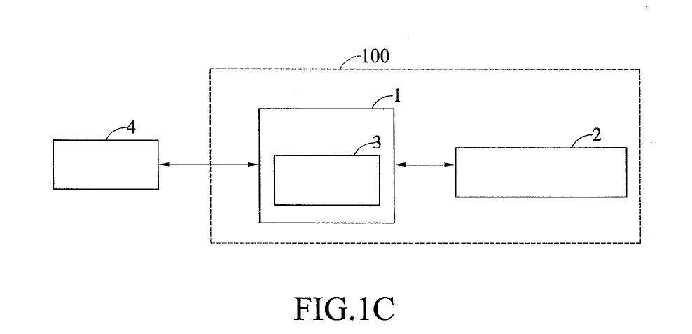

FIG. 2 is a schematic block diagram showing an example of the system for sports data matching according to the present disclosure. Referring to FIGS. 1A to 1C and FIG. 2, the database 1 is used for storing data from the portable electronic device 2 and the processing device 3, and a plurality of pieces of objective data 11 are stored in the database 1.

The portable electronic device 2 has an input module 21, a memory module 22, a sensing module 23, a transmitting module 24, a display module 25 and a query module 26. The input module 21 is used for inputting user data 211 and sports place data 212 that are further transmitted to the memory module 22 for temporary storage. The sensing module 23 is used for providing environment data 231 and sports state data 232 that are further transmitted to the memory module 22 for temporary storage. The memory module 22 is used for generating memory data according to at least one of the user data 211, the sports place data 212, the environment data 231, the sports state data 232 and a combination thereof. Further, the memory module 22 transmits the memory data through the transmitting module 24 to the database 1 for storage, thereby creating a new piece of objective data 11 in the database 1. Furthermore, the memory data is transmitted through the transmitting module 24 to the processing device 3. The query module 26 is used for querying the memory data or the objective data 11 of the database 1 and the querying result is displayed by the display module 25.

The user data 211 can include, for example, the name, age, weight, height, gender, sports qualification and sports type of the user. The sports type can be a ball type such as basketball or football, or a racing type, such as running, swimming, skating, skiing and cycling. If the sports type is cycling, the user data 211 further includes data on equipment and type of bicycles and so on. If the sports type is swimming, the user data 211 further includes swimming stroke data. The sports place data 212 includes the name of the sports place, such as the Municipal Stadium or HouFong Bikeway, or the name of the field position. The environment data 231 includes data on wind resistance, temperature, humidity or crowd density of the current sports environment or a combination thereof. The environment data 231 can be captured from an external environment platform such as the weather bureau, or captured from a device carried by the user, for example, a wind resistance meter or a temperature and humidity meter. The sports state data 232 includes sports data of the user that is sensed by the sensing module 23, for example, data on sports heart rates, sports paths, sports positions, sports time, height or slope of the sports path, bicycle rotating speeds (in the case of a cycling sport) or a combination thereof. The sports time data includes data on sports starting time, duration and ending time. The sports time data can be recorded by a stopwatch or recorded according to the national standard time, or recorded by a combination of these two methods. Further, the sports state data 232 can be ball type sports data, such as data on scores and turnovers. The objective data 11 includes memory data that is stored in the database 1 and integrated with one or more of the user data 211, the sports place data 212, the environment data 231 and the sports state data 232, and result data after comparison, analysis or integration.

The processing device 3 includes at least one of a communication module 31, an analyzing module 32 and an integrating module 33. In an embodiment, the processing device 3 includes all of them. The communication module 31 receives the objective data 11 from the database 1 and the memory data from the portable electronic device 2, and transmits the objective data 11 and the memory data to the analyzing module 32. The analyzing module 32 analyzes and compares the objective data 11 and the memory data so as to generate comparison data that is further transmitted to the integrating module 33. The integrating module 33 integrates the comparison data and the memory data so as to generate result data that is further outputted through the communication module 31 to the database 1 for integration and storage.

In the case that the sports type of the user data 211 is a racing type, such as running or cycling, the processing device 3 can define and number the sports path of the sports state data 232 and output the numbered sports path to the database 1 for storage. The numbered sports path can be used as reference data for finding sports partners.

The method of defining a sports path by the processing device 3 is detailed as follows. When the portable electronic device 2 starts the sensing module 23, the memory module 22 records a starting point, and then records an address point at a regular interval of, for example, one second. As such, a plurality of address points are recorded within certain sports duration. Thereafter, the memory module 22 integrates the address points into the memory data that is further transmitted to the database 1 for storage. Then, the processing device 3 captures the objective data 11 and the memory data having the address points from the database 1 through the communication module 31 and transmits them to the analyzing module 32, and the analyzing module 32 processes the address points so as to generate a sports track. The recorded starting point and the sports track are defined as a sports path.

The sports path can be recorded by a global positioning system (GPS) or latitude and longitude coordinates.

The method of numbering a sports path by the processing device 3 is detailed as follows. According to an error range set by the user, the analyzing module 32 compares the sports path with a sports path of the objective data 11. If the difference between the sports paths falls within the allowable error range, the sports path is numbered with the same number as the sports path of the objective data 11. Otherwise, if the difference between the sports paths does not fall within the allowable error range, the sports path is numbered with a new number. By defining and numbering sports paths through the processing device 3, data on the sports paths in the same sports place can be integrated and classified so as to facilitate the user to find appropriate virtual sports partners.

In the case that the sports type of the user data 211 is a ball type, such as basketball, football, baseball, tennis, badminton or a combination thereof, the sports state data 232 includes sports data on, for example, scores, goal attempts, assists, turnovers, hits or pitch speeds.

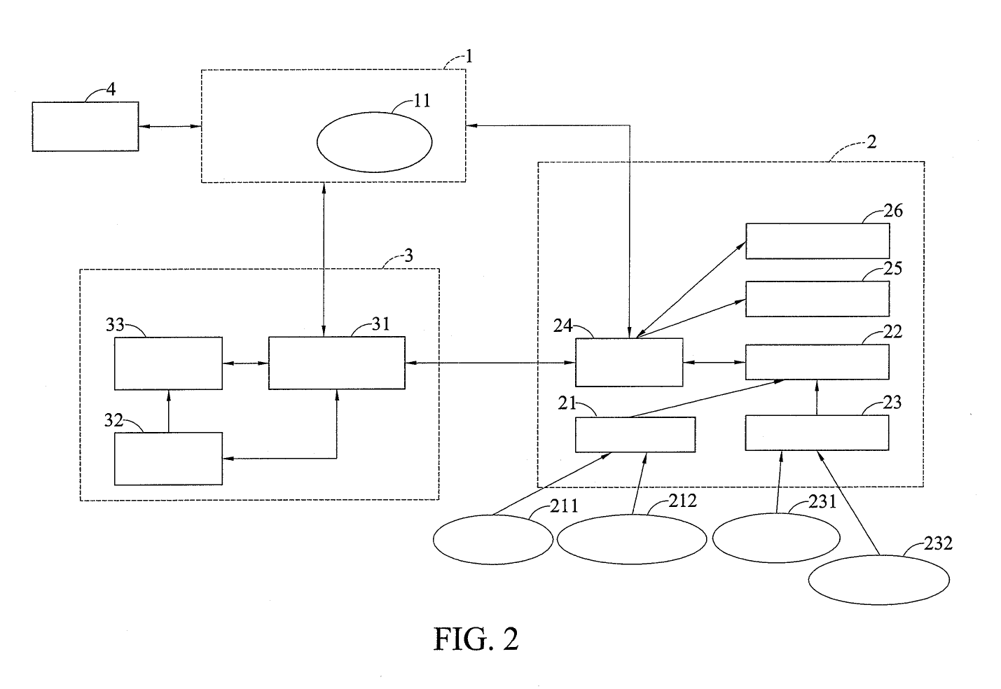

FIG. 3 is a schematic block diagram of the analyzing module 32 of the system for sports data matching according to the present disclosure.

Referring to FIGS. 1 to 3, in the case that the sports type of the user data 211 is a racing or ball type, the user can preset the same or related data on one or a combination of a predetermined running path, objective energy consumption, sports time, suggested players for formation of a team or team composition for a ball game, which is used as a basis (for example, having the predetermined or related running path) for the objective of subsequent analysis and comparison of the processing device 3. Further, the user can set a first error range to be used by the analyzing module 32 for comparison. According to the objective and the first error range, the analyzing module 32 analyzes and compares each piece of the user data 211 of the memory data 221 with the corresponding piece of the objective data 11. Alternatively, the analyzing module 32 can integrate the user data 211 into a parameter set and integrate the objective data 11 into another parameter set for analysis and comparison. In addition, one or more of the sports place data 212, the sports state data 232 and the environment data 231 of the memory data 221 can be included as reference data for analysis and comparison. As such, the analyzing module 32 generates comparison data 321 that meets the objective and falls within the first error range.

Optionally, the user can set a predetermined value for the number of times or the ratio a user name appears. For example, the predetermined value for the number of times the user name appears is set to be 10 or a certain ratio is set. The objective data 11 is analyzed and compared with the memory data according to the objective and the first error range and other user names that meet the predetermined value for the number of times or the certain ratio are chosen so as to generate comparison data 321. The name can include at least one of the other user names or the user name of the portable electronic device.

In an embodiment, the wind resistance data of the environment data 231 can be used as main reference data for analysis and comparison so as to improve the matching effect between the users and facilitate to find appropriate virtual sports partners.

Further, the analyzing module 32 outputs the comparison data 321 and the memory data 221 to the integrating module 33 for integration, thereby creating sports result data. The communication module 31 further outputs the sports result data to the database 1, and the sports result data is stored in the database 1 to update the objective data 11. In the case that the processing device 3 does not include the integrating module 33, the comparison data 321 and the memory data 221 are outputted to the database 1 for integration and the integrated result is stored in the database 1 for updating the objective data 11.

In an embodiment, the comparison data 321 includes part of or all of one or more of the user data, the sports place data, the sports state data and the environment data of other users, i.e., virtual sports partners. As such, when the result data from the database 1 is received by the portable electronic device 2 through the transmitting module 24 and displayed by the display module 25, the user can know sports performance of his/her own and the other users or know whether the other users are complementary or similar players so as to facilitate formation of a team. The user can also know at least one kind of team composition result for a ball game.

In an embodiment, the sports data matching system 100 can be used to record sports data and strength grades of teams so as to improve the matching effect between the teams.

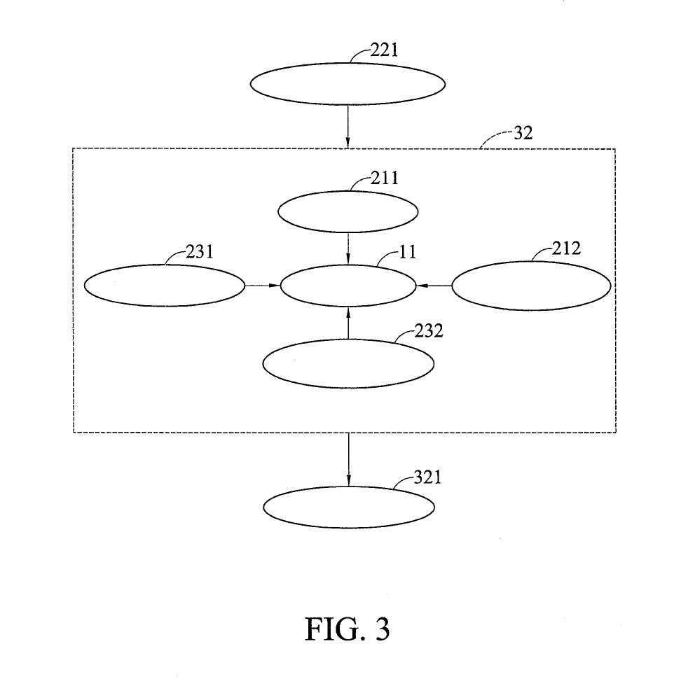

FIG. 4 is a schematic block diagram showing another example of the system for sports data matching according to the present disclosure.

The above-described team composition result or preset team composition data is stored in the memory modules of the portable electronic devices 5, 6 so as to generate memory data. The portable electronic devices 5, 6 are respectively held by two teams who are about to play a ball game. If the portable electronic devices 5, 6 upload memory data of team data on, such as team composition and a first field position (for example, team name, grade or team member data), to the database 1 within a certain time period and/or a certain range of the field position and the uploaded first field position data meets a second field position data of the database 1, the first field position data is defined as the sports place name for the ball game, which ensures the correctness of the sports data of the teams and prevents a data error caused by a casual input of a sports place position by a user. On the other hand, if the first field position data does not meet the second field position data of the database 1, the first field position data becomes potential or candidate field position data and is verified by a manager so as to define the first field position data as the sports place name for the ball game. The first field position data and the second field position data are recorded by a global positioning system (GPS) or latitude and longitude coordinates.

The method of defining the sports place name through the first field position data is detailed as follows. Each piece of the objective data 11 of the database 1 further includes a numbered second field position data. The user can set a second error range for analysis and comparison of the analyzing module 32. The analyzing module 32 captures the second field position data and the first field position data from the database 1 through the communication module 31 so as to analyze and compare the first field position data and the second field position data according to the second error range. If the difference between the first field position data and the second field position data falls within the allowable second error range, the first field position data is numbered with the same number as the second field position data. Otherwise, if the difference between the first field position data and the second field position data does not fall within the allowable second error range, the first field position data becomes potential or candidate field position data and is verified by a manager so as to be numbered with a new number. Then, the numbered first field position data is outputted to the database 1 for storage and integration, thereby updating the second field position data of the database 1.

Further, if the sports data of a team stored in the database 1 reaches a preset range value, a strength ranking can be performed between the team and other teams. In particular, according to one or a combination of the sports data of the teams on gain to loss ratio, difference between gain and loss, accumulated points and so on, the analyzing module 32 of the processing device 3 uses a statistical method to generate statistical data for analysis and comparison, thereby generating team ranking data. The team ranking data is further outputted by the processing device 3 to the database 1 for storage, thereby updating the object data 11 and improving the matching effect between the teams.

In addition, if a grading system such as a football or basketball league is applied to the team competition, in addition to the strength ranking data of the teams, a dynamic ranking of strength grades is also performed to the teams. In particular, the analyzing module 32 analyzes and compares the sports data to generate strength ranking data of the teams in each grade, and the strength ranking data of the teams in each grade is further outputted to the database 1 for storage, thereby updating the objective data 11. If a team rises from a preset ranking within a certain time period such as a year or a season, the team is upgraded. Otherwise, if the team falls off the preset ranking, the team is downgraded. As such, each team can find a matching team according to the ranking data of strength grades, thereby increasing the sports entertainment and interactivity and improving the matching effect. It should be noted that the above-described strength ranking or strength grade ranking can also be applied to individual persons so as to increase the interactivity and improving the matching effect between the persons.

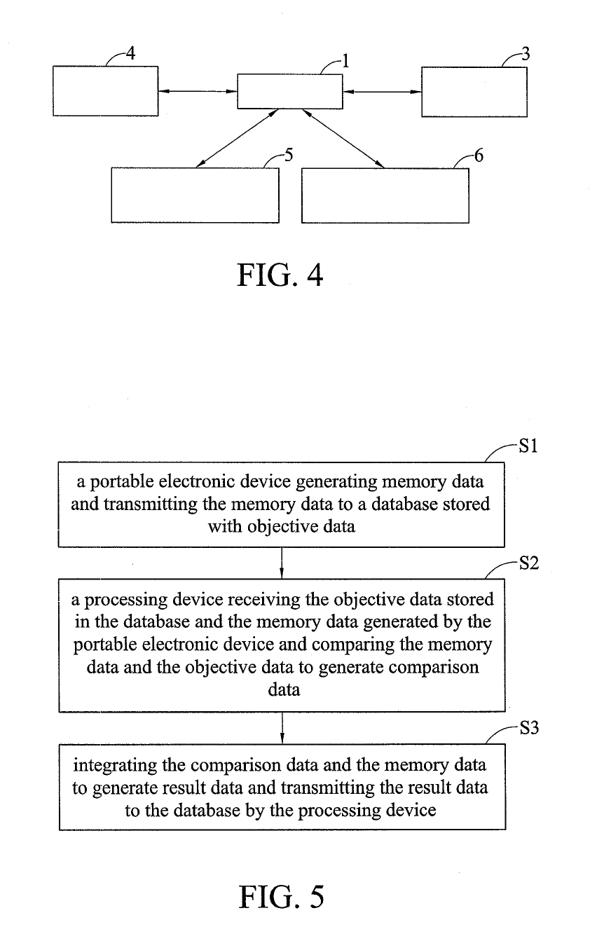

FIG. 5 is a schematic flow diagram showing a method for sports data matching according to the present disclosure. First, in step S1, a portable electronic device generates memory data and transmits the memory data to a database having objective data. Then, the method goes to step S2.

In step S2, a processing device receives the objective data stored in the database and the memory data generated by the portable electronic device and compares the memory data with the objective data to generate comparison data.

In step S3, the comparison data and the memory data are integrated to generate result data, which is outputted by the processing device to the database.

Further, the memory data includes wind resistance data to improve the matching effect between the user and other users, and facilitate finding appropriate virtual sports partners.

According to the present disclosure, the portable electronic device provides data on current sports environment for comparison and analysis so as to facilitate to find appropriate virtual sports partners.

Further, users can capture results of different types of sports from the database and share them in a community website, thereby increasing the interactivity between the users. Furthermore, by querying the objective data of the database, history sports records can be acquired so as to facilitate to adjust the sports state and find appropriate virtual sports partners, thereby improving the sports training effect, facilitating rapid formation of a team for competition, and increasing the interactivity between the users.

In addition, wind resistance data can be included for analysis and comparison so as to improve the matching effect between the users and facilitate to fine appropriate sports partners.

The above-described descriptions of the detailed embodiments are only to illustrate the preferred implementation according to the present disclosure, and it is not to limit the scope of the present disclosure. Accordingly, all modifications and variations completed by those with ordinary skill in the art should fall within the scope of the present invention defined by the appended claims.

What is claimed is:

1. A system for sports data matching, comprising:
a database configured to store objective data;
a portable electronic device configured to generate memory data and transmit the memory data to the database; and
a processing device electrically connected to the database and the portable electronic device, and configured to capture the memory data generated by the portable electronic device and the objective data stored in the database and compare the memory data with the objective data to generate comparison data.

2. The system of claim 1, wherein the portable electronic device comprises:
an input module configured to input user data and sports place data;
a sensing module configured to sense environment data and sports state data;
a memory module configured to generate the memory data according to at least one of the user data, the sports place data, the environment data and the sports state data; and
a transmitting module configured to transmit the memory data generated by the memory module to the database for storage.

3. The system of claim 2, wherein the environment data comprises wind resistance data, and the memory module is configured to generate the memory data having the wind resistance data.

4. The system of claim 3, wherein the processing device is configured to compare the memory data having the wind resistance data generated by the memory module of the portable electronic device with the objective data to generate the comparison data.

5. The system of claim 2, wherein the sports state data comprises at least one of a ball type sports data and a racing type sports data.

6. The system of claim 5, wherein the processing device is configured to capture the ball type sports data or the racing type sports data and compare the ball type sports data or the racing type sports data with the objective data to generate the comparison data.

7. The system of claim 5, wherein the ball type sports data comprises data on scores, goal attempts, assists, turnovers, hits, pitch speeds or sports positions of a ball type sport, and the ball type sport is at least one of basketball, football, baseball, tennis, badminton, and a combination thereof.

8. The system of claim 5, wherein the racing type sports data comprises data on sports paths, sports positions or sports duration of a racing type sport, and the racing type sport is at least one of running, swimming, skating, skiing, cycling and a combination thereof.

9. The system of claim 8, wherein the sports paths or the sports positions are recorded according to global positioning or latitude and longitude coordinates.

10. The system of claim 1, wherein the processing device comprises an analyzing module configured to receive the memory data and the objective data and compare the memory data with the objective data to generate the comparison data.

11. The system of claim 10, wherein the analyzing module is further configured to generate data on sports paths or sports positions, mark the sports paths or the sports positions with a number, and transmit the number to the database for storage.

12. The system of claim 11, wherein the sports paths or the sports positions are recorded according to global positioning or latitude and longitude coordinates.

13. The system of claim 10, wherein the analyzing module is further configured to calculate ranking data according to the objective data.

14. The system of claim 1, wherein the processing device comprises an integrating module configured to integrate the comparison data and the memory data to generate result data.

15. The system of claim 14, wherein the processing device further comprises a communication module configured to transmit the result data to the database for storage.

16. The system of claim 15, wherein the portable electronic device comprises a transmitting module configured to receive the result data from the database, and the portable electronic device further comprises a display module configured to display the result data.

17. The system of claim 1, further comprising a community website configured to access the database.

18. A method for sports data matching, comprising:
generating memory data and transmitting the memory data to a database stored with objective data by a portable electronic device;
receiving the objective data stored in the database and the memory data generated by the portable electronic device, and comparing the memory data with the objective data to generate comparison data by a processing device; and
integrating the comparison data and the memory data to generate result data, and transmitting the result data to the database for storage by the processing device.

19. The method of claim 18, further comprising sensing environment data including wind resistance data by a sensing module of the portable electronic device.

20. The method of claim 18, wherein generating the memory data comprising generating the memory data according to the environment data including the wind resistance data by a memory module of the portable electronic device.
